(19) United States
(12) Patent Application Publication
(10) Pub. No.: US 2014/0377536 A1
(43) Pub. Date: Dec. 25, 2014

(54) ADHESIVE TAPE

(71) Applicant: Hon Hai Precision Industry Co., Ltd., New Taipei (TW)

(72) Inventors: PEI-RONG SHIEH, New Taipei (TW); CHANG-CHIN WU, New Taipei (TW)

(73) Assignee: HON HAI PRECISION INDUSTRY CO., LTD., New Taipei (TW)

(21) Appl. No.: 14/058,447

(22) Filed: Oct. 21, 2013

(30) Foreign Application Priority Data
Jun. 19, 2013 (TW) 102121639

(51) Int. Cl. C09J 7/02

(52) U.S. Cl. CPC C09J 7/0289; C09J 7/0235; C09J 2201/122
USPC 428/325; 428/327; 428/328

(57) ABSTRACT

An adhesive tape is disclosed. The adhesive tape includes a protective layer, an adhesive layer formed on the protective layer, and a plurality of bearing particles dispersed in the adhesive layer. The bearing particle is hollow, and includes an elastic shell and a filling body received in the elastic shell. The elastic shell defines a plurality of through holes. The filling body is adhesive. An impact resistance of the adhesive tape is improved, and an adhering performance is improved.

### BACKGROUND

1. Technical Field

The present disclosure relates to adhesive tapes, and particularly to a double-sided adhesive tape.

2. Description of the Related Art

A double-sided adhesive tape includes a base layer and two adhesive layers formed on opposite surfaces of the base layer. The base layer is made of foam having air bubbles. The air bubbles are formed by expanding resin particles in a chemical method or by introducing air into the foam in a physical method. In those methods, the sizes of the air bubbles are difficult to control. Some air bubbles may be broken when the adhesive tape comes under stress. Thus, in use, the double-sided adhesive tape suffers an uneven stress, so that the tape cannot bear a predetermined force.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 shows a partial, cross-sectional view of a first embodiment of an adhesive tape, including a plurality of bearing particles.

FIG. 2 shows a cross-sectional view of the bearing particle of the FIG. 1.

FIG. 3 is similar to FIG. 1, but showing the adhesive tape in a use state.

FIG. 4 shows a partial, cross-sectional view of a second embodiment of an adhesive tape.

FIG. 5 is similar to FIG. 4, but showing the adhesive tape in a use state.

### DETAILED DESCRIPTION

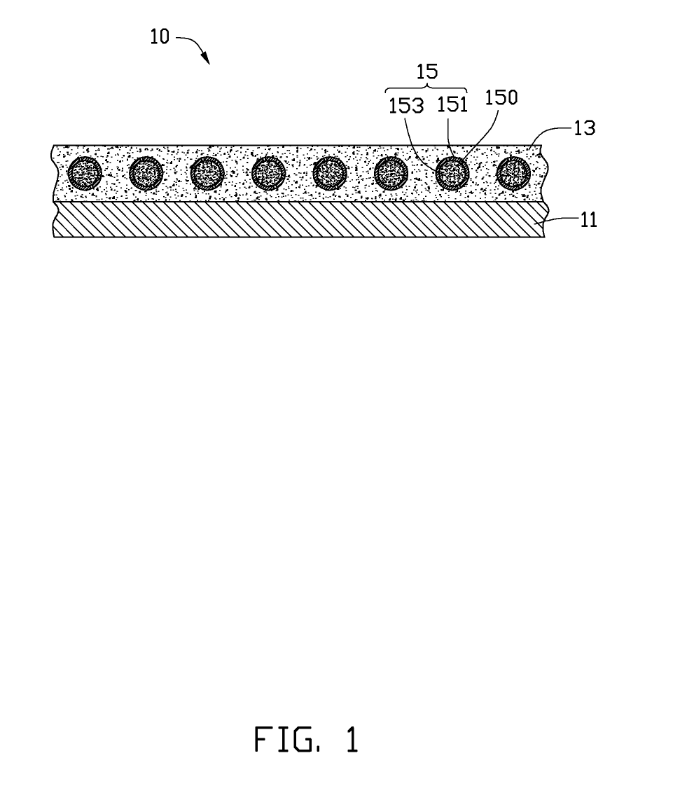

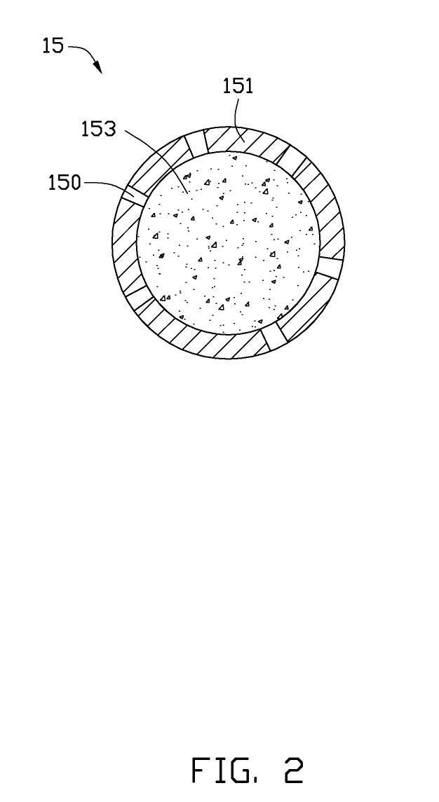

FIGS. 1 and 2 show a first embodiment of an adhesive tape 10. The adhesive tape 10 includes a protective layer 11, an adhesive layer 13 formed on the protective layer 11, and a plurality of bearing particles 15 dispersed in the adhesive layer 13. The protective layer 11 is made of release paper. The adhesive layer 13 is made of adhesive, for adhering to articles (not shown). The bearing particle 15 is hollow and spherical, and includes an elastic shell 151 and a filling body 153 received in the elastic shell 151. The elastic shell 151 defines a plurality of through holes 150. The filling body 153 is adhesive.

The elastic shell 151 is made of materials selected from a group of the following materials: organic polymer, metal, or ceramic, for example. The organic polymer can be selected from a group consisting of vinylidene chloride acrylonitrile copolymer, poly (vinyl alcohol), poly (vinyl butyral), polymethyl methacrylate (PMMA), polyacrylonitrile, poly (vinylidene chloride), and polysulfones, for example. The metal can be stain steel, titanium, copper, or alloys thereof. The ceramic can be silicon dioxide-organic polymer hybrid material or hollow glass ceramic, for example.

In the first embodiment, the elastic shell 151 is made of vinylidene chloride acrylonitrile copolymer. The filling body 153 is made of an acrylic adhesive. In other embodiments, the filling body 153 can be made of other adhesives, such as a rubber.

In the first embodiment, a size of the bearing particle 15 is about a half of a thickness of the adhesive layer 13. A density of the bearing particles 15 and the adhesive layer 13 is about 0.6 kilograms per cubic meter. In other embodiments, the size of the bearing particle 15 can be greater than a half of the thickness of the adhesive layer 13. The density of the bearing particles 15 and the adhesive layer 13 can be in a range from about 0.3 kilograms per cubic meter to about 0.9 kilograms per cubic meter. In the first embodiment, the bearing particles 15 are uniformly dispersed in the adhesive layer 13.

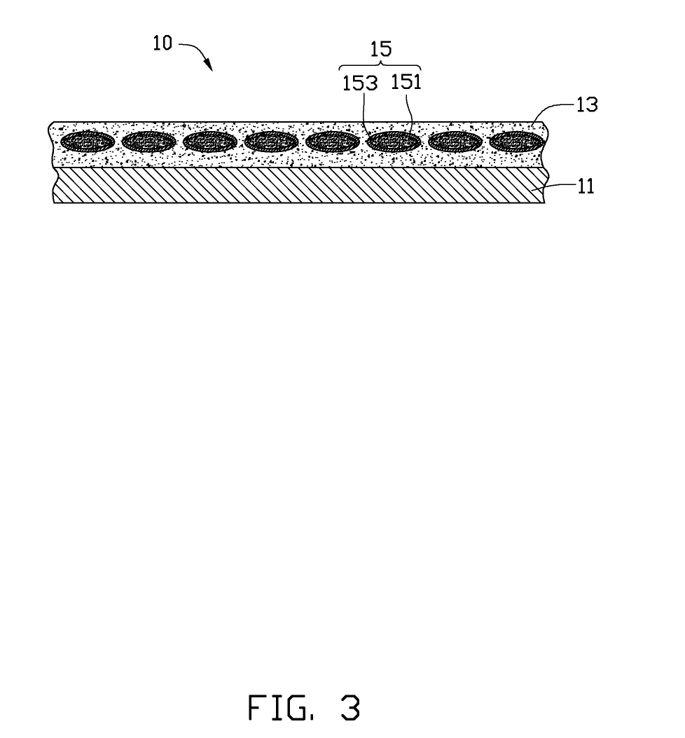

In the first embodiment, the adhesive tape 10 employs the bearing particles 15 as a base layer. When the adhesive tape 10 comes under stress, the elastic shells 151 are deformed elastically (referring to FIG. 3), and not easily broken, such that the stress is dispersed effectively, and uniformly exerted on the adhesive tape 10. Thus, an impact resistance of the adhesive tape 10 is improved, and an adhering performance is improved. A glass transition temperature of the bearing particle 15 is high, so that a temperature resistance of the adhesive tape 10 is higher, and a shearing strength of the adhesive tape 10 is improved. In addition, the filling bodies 153 are extruded in the adhesive layer 13 via the through holes 150 when under stress, so that the adhering performance is further improved. Furthermore, the adhesive tape 10 has a simpler structure, has a simpler manufacturing process. First, the bearing particles 15 are dispersed in the adhesive. The adhesive is coated on the protective layer 11.

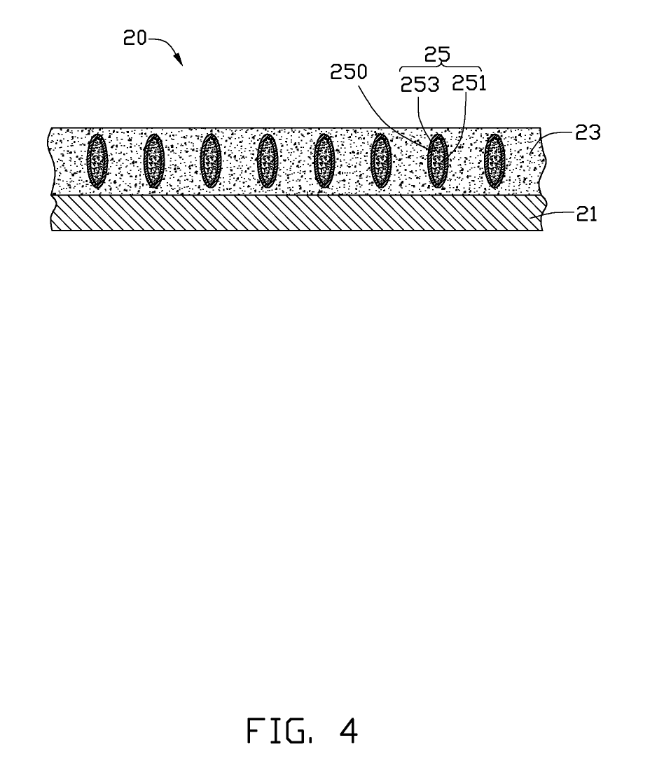

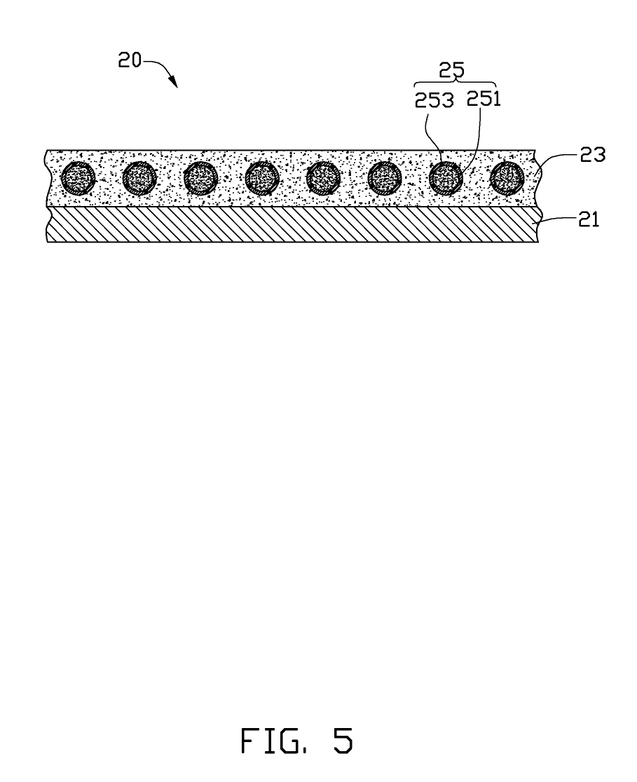

FIGS. 4 and 5 show a second embodiment of an adhesive tape 20. The adhesive tape 20 is similar to the first embodiment of the adhesive tape 10, and includes a protective layer 21. An adhesive layer 23 is formed on the protective layer 21, and a plurality of bearing particles 25 are dispersed in the adhesive layer 23. However, each bearing particle 25 is hollow, and includes an elastic shell 251 and a filling body 253 received in the elastic shell 251. The elastic shell 251 defines a plurality of through holes 250. However, the elastic shell 251 is elliptical, and a size of each bearing particle 25 is greater than a half of a thickness of the adhesive layer 23. In use, if the adhesive tape 20 under stress, the bearing particles 25 are deformed (shown in FIG. 5).

The bearing particles 15, 25 are not limited to above-described shapes, and can be in other shapes, regular or irregular, such as cubic or polygon.

It is to be understood, however, that even though numerous characteristics and advantages of the disclosure have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. An adhesive tape, comprising:
a protective layer;
an adhesive layer formed on the protective layer; and
a plurality of bearing particles dispersed in the adhesive layer, each of the bearing particles comprising an elastic shell and a filling body received in the elastic shell, the elastic shell defining a plurality of through holes, the filling body being made of adhesive.

2. The adhesive tape of claim 1, wherein the elastic shell is made of materials selected from a group consisting of organic polymer, metal, and ceramic.

3. The adhesive tape of claim 2, wherein the elastic shell is made of materials selected from a group consisting of vinylidene chloride acrylonitrile copolymer, poly (vinyl alcohol), poly (vinyl butyral), polymethyl methacrylate, polyacrylonitrile, poly (vinylidene chloride), and polysulfones.

4. The adhesive tape of claim 2, wherein the elastic shell is made of materials selected from a group consisting of stain steel, titanium, copper, and alloys thereof.

5. The adhesive tape of claim 2, wherein the elastic shell is made of silicon dioxide-organic polymer hybrid material or hollow glass ceramic.

6. The adhesive tape of claim 1, wherein the each of the bearing particles is spherical or elliptical.

7. The adhesive tape of claim 1, wherein the filling body is made of rubber or acrylic resin.

8. The adhesive tape of claim 1, wherein the plurality of bearing particles are uniformly dispersed in the adhesive layer.

9. The adhesive tape of claim 1, wherein a size of the each of the bearing particles is equal to or greater than a thickness of the adhesive layer.

10. The adhesive tape of claim 1, wherein a density of the plurality of bearing particles and the adhesive layer is in a range from about 0.3 kilograms per cubic meter to about 0.9 kilograms per cubic meter.
